(19) United States
(12) Patent Application Publication
(10) Pub. No.: US 2026/0178513 A1
(43) Pub. Date: Jun. 25, 2026

(54) FAST AND SECURE MEMORY ADDRESS TRANSLATION IN A VIRTUAL MACHINE COMPUTING SYSTEM

(71) Applicant: NVIDIA Corporation, Santa Clara, CA (US)

(72) Inventors: Hemayet HOSSAIN, San Jose, CA (US); Wishwesh Anil GANDHI, Sunnyvale, CA (US); Himaja S. VALAVALA, Santa Clara, CA (US); Lucien DUNNING, Santa Clara, CA (US); Abhishek BASAK, Bothell, WA (US); Piyush PATEL, Cary, NC (US); Rohan KANSAL, Austin, TX (US); James Leroy DEMING, Madison, AL (US)

(21) Appl. No.: 19/415,618

(22) Filed: Dec. 10, 2025

Related U.S. Application Data
(60) Provisional application No. 63/736,775, filed on Dec. 20, 2024.

(51) Int. Cl. G06F 12/14; G06F 7/72

(52) U.S. Cl. CPC G06F 12/145; G06F 7/721; G06F 12/1458; G06F 2212/1052

(57) ABSTRACT

Various embodiments include techniques for translating memory addresses in a virtualized computing system that hosts multiple virtual machines. In such a virtualized computing system, conventional approaches for translating a guest virtual address to a system physical address can involve a large number of memory accesses. With the disclosed techniques, address translation can be reduced to approximately 5 memory accesses. This performance savings results from storing two data structures in high-speed on-chip memory that indicate which system physical address segments are mapped to and valid for the virtual machine that is accessing the memory segment. A third data structure indicates whether a system physical address segment is a protected/secure system physical address segment. If the virtual machine already has access to the segment, then confidential/secure compute policies can be applied on the accesses from this virtual machine based on whether this system physical segment is protected/secure.

### CROSS-REFERENCE TO RELATED APPLICATIONS

This application claims priority benefit of the United States Provisional Patent Application titled, “FAST AND SECURE ADDRESS TRANSLATION,” filed on Dec. 20, 2024, and having Ser. No. 63/736,775. The subject matter of this related application is hereby incorporated herein by reference.

### BACKGROUND

### Field of the Various Embodiments

Various embodiments relate generally to computer system architecture and, more specifically, fast and secure memory address translation in a virtual machine computing system.

### DESCRIPTION OF THE RELATED ART

A computing system generally includes various components, such as, among other things, one or more processing units, such as central processing units (CPUs) and/or graphics processing units (GPUs), one or more memory systems, and other devices. CPUs and GPUs typically have multiple processors that execute multiple processes and/or threads. Additionally or alternatively, the multiple processors can execute multiple instances of the same processes and/or threads. As a result, modern CPUs and GPUs are able to achieve significant performance levels. For simplicity, the term “thread” is used herein to denote any instruction execution stream, whether in the form of a process, thread, application program, and/or the like.

Certain computing systems support virtualization, which is a mechanism that allows multiple guest operating systems (OSs) to use portions of the same hardware (HW) platform simultaneously. In such systems, control software referred to as a hypervisor assigns portions of the resources of the hardware platform into multiple virtual machines (VMs). Each VM executes a different guest OS and employs the system resources assigned to the VM by the hypervisor to perform various tasks. The hypervisor also executes a hypervisor OS for the purpose of managing and isolating available resources of the computing system among the VMs executing on the computing system.

In computing systems that support virtualization, memory addresses accessed by VMs undergo a multistage memory address translation process. When accessing data in memory, software application programs executing on a VM generate memory requests that include guest virtual addresses (GVAs). These guest virtual addresses are in a guest virtual memory address range that is accessible to the VM and to the guest OS. In a first stage of address translation, the computing system translates the guest virtual address (the input address) generated by the software application program into a guest physical address (the output address). The guest physical address (GPA) is in a guest physical address range as viewed by the guest OS. In a second stage of address translation, the computing system translates the guest physical address (the input address) into a system physical address (the output address). The system physical address (SPA) is in a system physical address range as viewed by the hypervisor OS. Each of these two stages involves looking up the input address in a page table that includes address translations and retrieving a corresponding output address.

Each of the first stage and the second stage of address translation can take place over multiple steps, referred to as levels, in a hierarchical memory-based page table system. Typically, each stage of address translation can involve multiple levels of page tables, where the page tables for all or some levels are stored in memory. For example, if the first stage and the second stage both perform a multi-level address translation, then address translation for a memory request involves two sets of multiple sequential memory requests. Each level of first stage memory address translation (for GVA to GPA translation) involves multiple page table memory accesses (M), and each level of second stage memory address translation (for GPA to SPA translation) involves another set of multiple page table memory accesses (N), for a total of M×N page table memory accesses per address translation.

One problem with this approach for translating guest virtual addresses to guest physical addresses and then to system physical address is that performing a large number of page table memory accesses for each memory access by a software application program can result in a significant negative impact on system performance. This negative impact on system performance can be mitigated by including a cache memory of recent address translations in the memory system. This cache memory of recent address translations is referred to as a translation lookaside buffer (TLB). With a TLB, the guest virtual address is used to access an entry in the TLB. If the TLB includes an entry with the guest virtual address, then the translation to the system physical address is retrieved from the entry of the TLB.

Although TLBs can be used to speed up the address translation process, TLBs exhibit certain shortcomings. TLBs can require significant integrated circuit chip surface area. As a result, TLBs can reduce the surface area available for other functions. Further, the TLBs can consume significant amounts of power, leading to higher operating temperature and reduced performance. These issues can be mitigated by reducing the size of the TLB. However, a smaller TLB increases the likelihood that the TLB does not have the capacity to store sufficient address translations to cover the working set of memory translation requests needed for a given software application program. Further, certain conditions can lead to the TLB not having any relevant address translations for a period of time. These certain conditions can include executing a software application program at power up, changing from executing from one software application program to executing another software application program, changing from executing a portion of a software application program that accesses one working set to a portion of the software application program that accesses another working set, and/or the like. In such cases, address translations for memory requests can involve a large number of page table memory accesses, described above, until the TLB has a sufficient number of recent page table translations that can be used for subsequent memory requests.

Further, in certain cases, the GPU system can support confidential computing. In such cases, the hypervisor cannot provide memory isolation and protection across VMs, because the VM does not trust the hypervisor for confidentiality and integrity of the relevant data. Memory isolation and protection can be critical requirements for virtualization technology where VMs are executing for different clients, where VMs are executing application programs that have a data security requirement, and/or the like. To support confidential computing, the second stage address translation mechanism can perform one or more operations to ensure that various software (SW) application programs executing on each VM only access physical addresses that the SW application programs are permitted to access by the hypervisor, as well as to ensure that the hypervisor cannot access memory allocated to VMs. Conventional approaches for ensuring that each SW application program only accesses physical addresses as permitted by the hypervisor can involve complex HW and SW implementations.

As the foregoing illustrates, what is needed in the art are more effective techniques for translating memory addresses in a virtualized computing system.

### SUMMARY

Various embodiments of the present disclosure set forth a computer-implemented method for translating memory addresses in a computing system. The method includes translating a first guest virtual address included in a first memory request to a first guest physical address. The method further includes determining a first guest physical address segment based on a first guest physical address. The method further includes determining that a mapping of the first guest physical address segment to a first system physical address segment exists. The method further includes determining that access to the first system physical address segment is valid for a processor that executed the first memory request. The method further includes determining a first system physical address based on the first guest physical address and on the mapping of the first guest physical address segment to the first system physical address segment.

Other embodiments include, without limitation, a system that implements one or more aspects of the disclosed techniques, and one or more computer readable media including instructions for performing one or more aspects of the disclosed techniques, as well as a method for performing one or more aspects of the disclosed techniques.

At least one technical advantage of the disclosed techniques relative to the prior art is that, with the disclosed techniques, performing second stage memory address translation in a virtualized computing system can utilize three data structures stored in high-speed local SRAM. By utilizing these three data structures, second stage memory address translation from a GPA to an SPA can be performed within a small number of clock cycles. By contrast conventional techniques perform second stage memory address translation via multiple sequential page table memory accesses, which can consume hundreds of clock cycles or more. As a result, performance of second stage memory address translation from GPA to SPA can be significantly improved relative to conventional techniques.

Further, with the virtualization mechanism can perform GVA to SPA translation via multiple sequential page table memory accesses for the first stage memory address translation plus a small number of clock cycles for the second stage memory address translation. By contrast conventional techniques perform GVA to SPA translation via multiple sequential page table memory accesses for first stage memory address translation (GVA to GPA) times multiple sequential page table memory accesses for second stage memory address translation (GPA to SPA). As a result, performance of GVA to SPA translation can also be significantly improved relative to conventional techniques.

Another advantage of the disclosed techniques relative to the prior art is that, with the disclosed techniques, the three data structures can be used to map SPA segments and unmap SPA segments from a VM faster relative to conventional techniques. In addition, a global segment protection mask data structure can be used in confidential computing applications to distinguish between protected or secure memory and unprotected or non-secure memory so that security policies can be enforced for confidentiality and integrity of protected data. These advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing system configured to implement one or more aspects of the various embodiments;

FIG. 2 is a block diagram of a parallel processing unit (PPU) included in the accelerator processing subsystem of FIG. 1, according to various embodiments;

FIG. 3 is a block diagram of a general processing cluster (GPC) included in the parallel processing unit (PPU) of FIG. 2, according to various embodiments;

FIG. 4 is a block diagram of a memory management subsystem included in the computing system of FIGS. 1-3, according to various embodiments;

FIG. 5 illustrates how the memory management subsystem of FIG. 4 maps guest physical address segments to system physical address segments, according to various embodiments;

FIGS. 6A-6B illustrate how the memory management subsystem of FIG. 4 manages dynamic mapping of guest physical address segments to system physical address segments using the per-VM VMMU segment mask and the per-VM VMMU segment valid mask, according to various embodiments;

FIGS. 7A-7B illustrate how the memory management subsystem of FIG. 4 manages static mapping of guest physical address segments to system physical address segments using the per-VM VMMU segment mask VMMU and the per-VM VMMU segment valid mask, according to various embodiments;

FIGS. 8A-8B illustrate how the memory management subsystem of FIG. 4 manages mapping of guest physical address segments to system physical address segments with a fixed number of segments per VM using the per-VM VMMU segment mask, according to various embodiments;

FIGS. 9A-9B illustrate how the memory management subsystem of FIG. 4 manages mapping of guest physical address segments to system physical address segments with a fixed number of segments per VM using the per-VM VMMU segment mask and the per-VM VMMU segment valid mask, according to various embodiments; and

FIGS. 10A-10B set forth a flow diagram of method steps for performing address translation with the memory management subsystem of FIG. 4, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

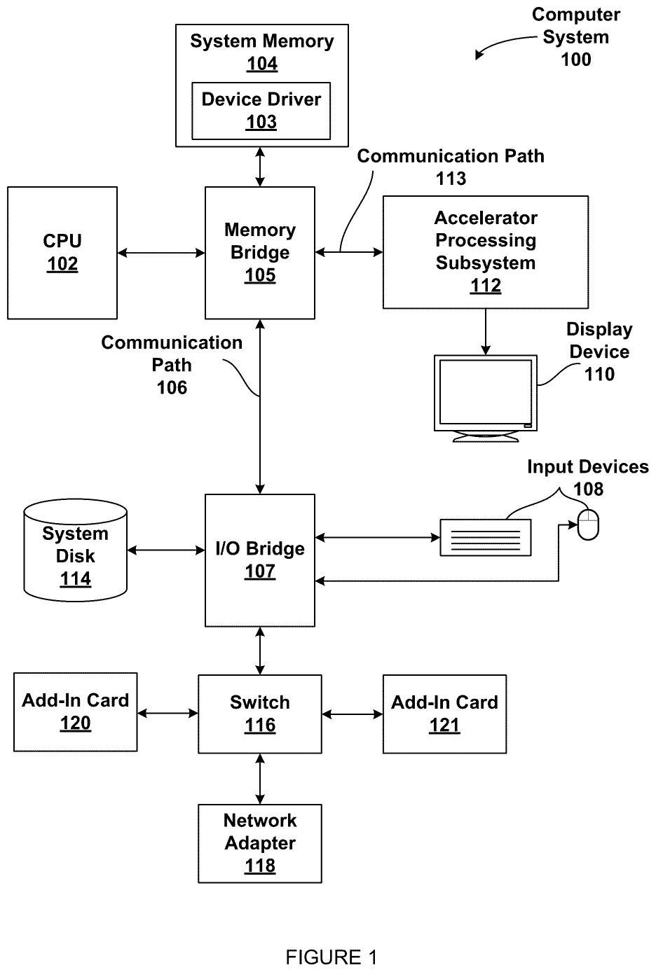

FIG. 1 is a block diagram of a computing system 100 configured to implement one or more aspects of the various embodiments. As shown, computing system 100 includes, without limitation, a central processing unit (CPU) 102 and a system memory 104 coupled to an accelerator processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. In some examples, input devices 108 are employed to verify the identities of one or more users in order to permit access of computing system 100 to authorized users and deny access of computing system 100 to unauthorized users. Switch 116 is configured to provide connections between I/O bridge 107 and other components of the computing system 100, such as a network adapter 118 and various add-in cards 120 and 121. In some examples, network adapter 118 serves as the primary or exclusive input device to receive input data for processing via the disclosed techniques.

As also shown, I/O bridge 107 is coupled to a system disk 114 that may be configured to store content and applications and data for use by CPU 102 and accelerator processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, Peripheral Component Interconnect Express (PCIe), HyperTransport, or any other bus or point-to-point communication protocol known in the art.

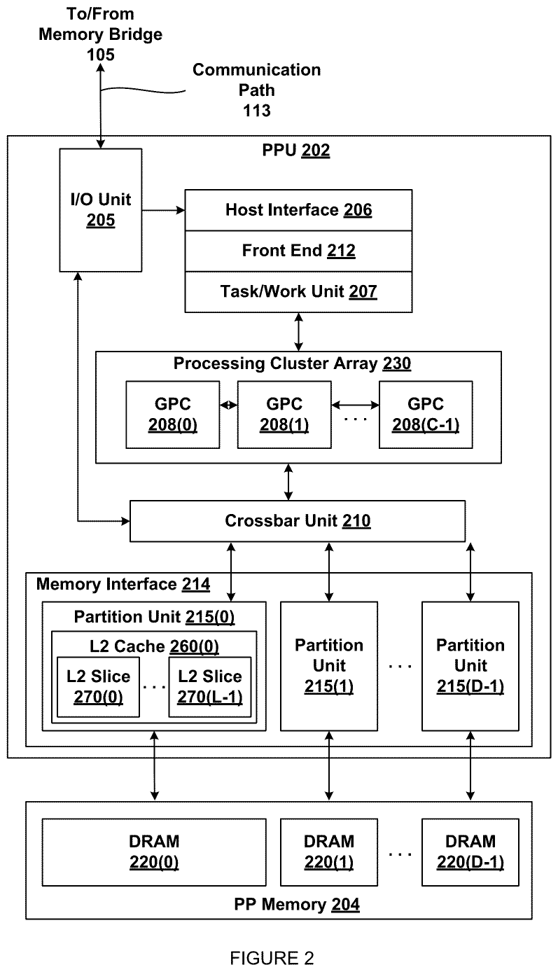

In some embodiments, accelerator processing subsystem 112 comprises a graphics subsystem that delivers pixels to a display device 110 that may be any conventional cathode ray tube, liquid crystal display, light-emitting diode display, or the like. In such embodiments, the accelerator processing subsystem 112 incorporates circuitry optimized for graphics and video processing, including, for example, video output circuitry. As described in greater detail below in FIG. 2, such circuitry may be incorporated across one or more accelerators included within accelerator processing subsystem 112. An accelerator includes any one or more processing units that can execute instructions such as a central processing unit (CPU), a parallel processing unit (PPU) of FIG. 2, a graphics processing unit (GPU), a direct memory access (DMA) unit, an intelligence processing unit (IPU), neural accelerator unit (NAU), tensor processing unit (TPU), neural network processor (NNP), a data processing unit (DPU), a vision processing unit (VPU), an application specific integrated circuit (ASIC), a field-programmable gate array (FPGA), and/or the like.

In some embodiments, accelerator processing subsystem 112 includes two processors, referred to herein as a primary processor (normally a CPU) and a secondary processor. Typically, the primary processor is a CPU and the secondary processor is a GPU. Additionally or alternatively, each of the primary processor and the secondary processor may be any one or more of the types of accelerators disclosed herein, in any technically feasible combination. The secondary processor receives secure commands from the primary processor via a communication path that is not secured. The secondary processor accesses a memory and/or other storage system, such as such as system memory 104, Compute eXpress Link (CXL) memory expanders, memory managed disk storage, on-chip memory, and/or the like. The secondary processor accesses this memory and/or other storage system across an insecure connection. The primary processor and the secondary processor may communicate with one another via a GPU-to-GPU communications channel, such as Nvidia Link (NVLink). Further, the primary processor and the secondary processor may communicate with one another via network adapter 118. In general, the distinction between an insecure communication path and a secure communication path is application dependent. A particular application program generally considers communications within a die or package to be secure. Communications of unencrypted data over a standard communications channel, such as PCIe, are considered to be unsecure.

In some embodiments, the accelerator processing subsystem 112 incorporates circuitry optimized for general purpose and/or compute processing. Again, such circuitry may be incorporated across one or more accelerators included within accelerator processing subsystem 112 that are configured to perform such general purpose and/or compute operations. In yet other embodiments, the one or more accelerators included within accelerator processing subsystem 112 may be configured to perform graphics processing, general purpose processing, and compute processing operations. System memory 104 includes at least one device driver 103 configured to manage the processing operations of the one or more accelerators within accelerator processing subsystem 112.

In various embodiments, accelerator processing subsystem 112 may be integrated with one or more other the other elements of FIG. 1 to form a single system. For example, accelerator processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of accelerator processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, accelerator processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the accelerator processing subsystem 112 of FIG. 1, according to various embodiments. Although FIG. 2 depicts one PPU 202, as indicated above, accelerator processing subsystem 112 may include any number of PPUs 202. Further, the PPU 202 of FIG. 2 is one example of an accelerator included in accelerator processing subsystem 112 of FIG. 1. Alternative accelerators include, without limitation, CPUs, GPUs, DMA units, IPUs, NAUs, TPUs, NNPs, DPUs, VPUs, ASICs, FPGAs, and/or the like. The techniques disclosed in FIG. 2 with respect to PPU 202 apply equally to any type of accelerator(s) included within accelerator processing subsystem 112, in any combination. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computing system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. Additionally or alternatively, processors and/or accelerators other than CPU 102 may write one or more streams of commands for PPU 202 to a data structure. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computing system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computing system 100 may be varied. In some embodiments, accelerator processing subsystem 112, which includes at least one PPU 202, is implemented as an add-in card that can be inserted into an expansion slot of computing system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≥1. As shown, each of the partition units 215 includes, without limitation, a level 2 (L2) cache 260. Each of the L2 caches 260 includes any number L of L2 slices 270(0) 270 (L−1), also referred to as L2 cache memory slices. Although only partition unit 215(0) is shown as having an L2 cache 260(0) that includes multiple L2 slices 270(0) . . . 270 (L−1), each partition unit 215 can include a different L2 cache 260 (not shown in FIG. 2), and each such L2 cache 260 can include any number of L2 slices 270 (not shown in FIG. 2). Each partition unit 215 is coupled to one or more dynamic random access memories (DRAMs) 220 residing within PP memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPC 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity, and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within accelerator processing subsystem 112, or another accelerator processing subsystem 112 within computing system 100.

As noted above, any number of PPUs 202 may be included in an accelerator processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

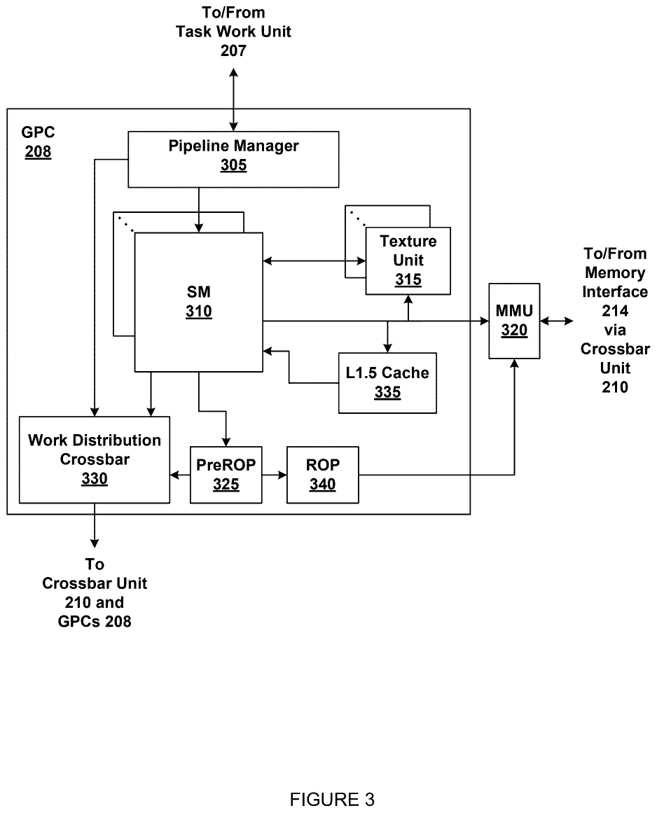

FIG. 3 is a block diagram of a general processing cluster (GPC) 208 included in the parallel processing unit (PPU) 202 of FIG. 2, according to various embodiments. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (e.g., AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310. In various embodiments, a software application program written in the compute unified device architecture (CUDA) programming language describes the behavior and operation of threads executing on GPC 208, including any of the above-described behaviors and operations. A given processing task may be specified in a CUDA program such that the SM 310 may be configured to perform and/or manage general-purpose compute operations.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches 260 that are shared among all GPCs 208 in PPU 202. The L2 caches 260 may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in one of the L2 caches 260, parallel processing memory 204, or system memory 104 via crossbar unit 210. In addition, a pre-raster operations (preROP) unit 325 is configured to receive data from SM 310, direct data to one or more raster operations (ROP) units 340 and/or other units via work distribution crossbar 330, perform optimizations for color blending, organize pixel color data, and perform address translations. ROP unit 340 performs various raster operations on input data received from preROP unit 325. ROP unit 340 performs various raster operations outputting to MMU (320). In particular, ROP unit 340 performs virtual memory read operations and/or virtual memory write operations directed to virtual memory addresses in order to blend pixels into the color buffer in main memory, such as PP memory 204, system memory 104, and/or the like. ROP unit 340 transmits virtual memory addresses to MMU 320 for translation to physical memory addresses. MMU 320 translates virtual memory addresses to physical memory addresses for these read operations and/or write operations. The read operations and/or write operations are directed to the resulting physical memory addresses. The read operations and/or write operations access physical memory addresses via crossbar unit 210 and memory interface 214.

It will be appreciated that the core architecture described herein is illustrative and that variations and modifications are possible. Among other things, any number of processing units, such as SMs 310, texture units 315, preROP units 325, ROP units 340, and/or the like can be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the various embodiments of the present disclosure.

Please note, as used herein, references to shared memory may include any one or more technically feasible memories, including, without limitation, a local memory shared by one or more SMs 310, or a memory accessible via the memory interface 214, such as a cache memory, parallel processing memory 204, or system memory 104. Please also note, as used herein, references to cache memory may include any one or more technically feasible memories, including, without limitation, an L1 cache, an L1.5 cache, and the L2 caches 260.

### Translating Memory Addresses in a Virtualized Computing System

Various embodiments include techniques for translating memory addresses in a virtualized computing system, such as computing system 100. In response to receiving a guest virtual memory address associated with a memory request, a memory management unit in the virtualized computing system performs two-stage memory address translation:(1) a first translation stage from a guest virtual memory address to a guest physical memory address; and (2) a second translation stage from a guest physical memory address to a system physical memory address. The first translation stage can include multilevel address translation involving traversing through multiple page tables stored in memory. Recent translations resulting from this first translation stage can be stored in a TLB.

The second translation stage includes a virtualization mechanism referred to as a virtual memory management unit (VMMU). The VMMU uses an on-chip high-speed static random access memory (SRAM) and/or other type of on-chip memory in order to avoid page table memory accesses and TLB memory accesses for the second translation stage. The VMMU divides up the entire system physical memory address space into a number of equally sized segments, where each segment is a contiguous block of system physical memory addresses used for memory management and access control. The segments can have configurable sizes, where the segment size is typically set by a secure entity at boot time, such as during power up, after system reset, and/or the like.

For each guest VM executing on the virtualized computing system, the VMMU stores two on-chip data structures in SRAM. The VMMU further stores a global on-chip data structure in SRAM. A first data structure is a per-VM VMMU segment mask data structure that includes one bit per system physical address segment. Each bit of the segment mask data structure indicates whether a mapping of the guest physical address segment to a system physical address segment exists. A second data structure is a per-VM VMMU segment valid mask data structure that includes one bit per system physical address segment. Each bit of the segment valid mask data structure indicates whether access to the system physical address segment is valid for the processor that executed a memory request that includes the guest virtual address. A third data structure is a global segment protection mask data structure for the entire GPU/PPU device memory that includes one bit per system physical address segment. Each bit of the segment protection mask data structure indicates whether the system physical address segment is a protected or secure segment. A VM accessing a secure and protected system physical segment is allowed access to the segment only if that VM has permission from the per-VM VMMU segment mask and the per-VM VMMU segment valid mask (e.g., the relevant bits in both masks are set to 1, i.e., logic TRUE, for that segment) as well as the condition that the correct security privileges have been configured in the MMU for that VM and the processor.

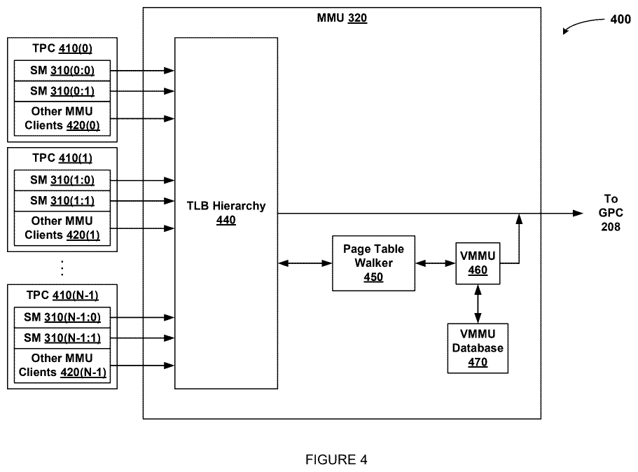

FIG. 4 is a block diagram of a memory management subsystem 400 included in the computing system 100 of FIGS. 1-3, according to various embodiments. As shown, memory management subsystem 400 includes, without limitation, multiple texture/processor clusters (TPCs) 410(0), 410(1), . . . 410 (N−1) and an MMU 320. MMU 320 functions as described in conjunction with FIG. 3 and as further described below. Multiple TPCs 410 can be included in each of the GPCs 208 of FIG. 2.

Each TPC 410 includes, without limitation, multiple SMs 310 as well as other MMU clients 420. As shown, each TPC 410 includes two SMs 310, although any one or more TPCs 410 can include any number of SMs 310. In particular, TPC 410(0) includes SM 310(0:0), SM 310(0:1), and other MMU clients 420(0). TPC 410(1) includes SM 310(1:0), SM 310(1:1), and other MMU clients 420(1). TPC 410 (N−1) includes SM 310 (N−1:0), SM 310 (N−1:1), and other MMU clients 420 (N−1). Similarly, other intervening TPCs 410 not specifically shown in FIG. 4 also include respective SMs 310 and other MMU clients 420.

In operation, SMs 310 generate memory requests that include guest virtual addresses. Likewise, other MMU clients 420 include any other processing elements and/or components that generate memory requests that include guest virtual addresses. Other MMU clients 420 can include, without limitation, one or more texture units, such as texture unit 315 of FIG. 3, 3D graphics processing engines, a level one cache memory, control logic, and/or the like.

MMU 320 includes, without limitation, a TLB hierarchy 440, a page table walker 450, a virtual memory management unit (VMMU) 460, and a VMMU database 470. MMU 320 performs first stage address translation to translate guest virtual addresses into guest physical addresses. Further, MMU 320 performs second stage address translation to translate these guest physical addresses to system physical addresses. As shown, TLB hierarchy 440 services the SMs 310(0:0)-310 (N−1:0) and SMs 310(0:1)-310 (N−1:1) as well as other MMU clients 420(0)-420 (N−1) included in the various TPCs 410(0)-410 (N−1). TLB hierarchy 440 stores the most recently translated addresses for SMs 310(0:0)-310 (N−1:0) and SMs 310(0:1)-310 (N−1:1) as well as other MMU clients 420(0)-420 (N−1), referred to collectively as MMU clients. When TLB hierarchy 440 receives a memory address translation request with a guest virtual address, TLB hierarchy 440 determines whether the address translation for the corresponding memory page is stored within TLB hierarchy 440 due to a recent address translation for that memory page. If the address translation for that memory page is stored within TLB hierarchy 440, then TLB hierarchy 440 transmits the corresponding system physical address to the GPC 208 that includes the requesting MMU client. If, however, the address translation for that memory page is not stored within TLB hierarchy 440, then TLB hierarchy 440 transmits the guest virtual address to page table walker 450.

In some embodiments, page table walker 450 can be included in a fill unit (not shown). Page table walker 450 walks, or traverses, the page tables of GPC 208 to perform memory address translations. Each step of the page table walk fetches the next level of page table entries until the final level is reached. The intermediate levels of page table entries are referred to as page directory entry levels (PDE levels). The final level of page table entries is referred to as the page table entry level (PTE level). PDEs point to a next level page table, while PTEs point to physical memory pages. Each PDE fetch or PTE fetch returns one or more guest physical addresses from memory. VMMU 460 is in the memory return path to page table walker 450 so that the guest physical addresses can be converted to system physical addresses. The Fill Unit uses these results from page table walker 450 to generate the fill response that is cached as a recent memory address translation in TLBs included in TLB hierarchy 440.

In some embodiments, TLB hierarchy 440 includes non-leaf TLBs (not shown) and leaf TLBs (not shown). Non-leaf TLBs return fill responses to TLBs in the next level of TLB hierarchy 440 that are serviced by the respective non-leaf TLBs. Eventually, the leaf TLBs receive the fill responses from non-leaf TLBs in the hierarchy chain. Each TLB in TLB hierarchy 440 caches the guest virtual address to system physical address translations, which are used to translate subsequent memory address translation requests received from various MMU clients.

In some embodiments, MMU clients can issue physical requests, where the memory address translation request includes a guest physical address rather than a guest virtual address. With such memory address translation requests, the received address is not translated with first stage address translation from guest virtual address to guest physical address. Instead, the received address is translated only with second stage address translation by VMMU 460 from guest physical address to system physical address. MMU 320 uses the same operational flow for physical requests as for virtual requests, except that page table walker 450 does not walk the first stage page tables. Instead, TLB hierarchy 440 transmits the guest physical address received with the memory address translation request directly to VMMU 460. The fill responses for the memory address translation request flow back to the leaf TLBs, and each TLB in TLB hierarchy 440 caches the fill responses. In these embodiments, TLB hierarchy 440 tags the cache lines to distinguish between cache lines associated with received guest physical addresses and cache lines associated with received guest virtual addresses.

In some embodiments, MMU 320 includes multiple VMMU instances. For example, MMU 320 can include a dedicated VMMU (not shown) to process address translations for a GPU-to-GPU communications channel, such as NVLink. To avoid stalling communications over NVLink, MMU 320 includes a dedicated TLB instance and VMMU for translating memory addresses for NVLink communications. As a result, incoming physical requests associated with NVLink do not need to use VMMU 460 for address translation. Because incoming NVLink requests are associated with a single guest MMU client, the NVLink VMMU associated with the NVLink needs only one set of segment masks and one set of segment valid masks, i.e., the equivalent of one set of masks for a single VM, rather than the full set of masks for multiple VMs, as for VMMU 460. Further, page table walker 450 has an additional VMMU instance to use for certain guest physical address to system physical address translations.

In some embodiments, VMMU 460 can invalidate one or more entries stored in the TLBs of TLB hierarchy 440. VMMU 460 can perform TLB invalidation under various conditions where one or more address translations stored in the TLBs of TLB hierarchy 440 are no longer accurate or valid. TLB address translations can be rendered invalid when any one or more page directory entries or page table entries relied on to generate the TLB address translations have changed after the TLB translations were stored in the TLBs of TLB hierarchy 440. In addition, VMMU 460 can perform TLB invalidation in response to an external trigger, such as an electronic signal generated by hardware, an instruction executed by software, and/or the like. VMMU 460 changes can result in changes to system physical addresses, thereby invalidating one or more address translations stored in the TLBs. Such VMMU changes can occur when a VM is terminated, when a VM context is swapped out, or some other VMMU change renders one or more TLB address translations invalid or stale.

In various embodiments, TLB hierarchy 440 can include TLBs of any cache memory type in any combination. For example, in some embodiments, the TLBs included in TLB hierarchy 440 can all be fully associative cache memories. Additionally or alternatively, the TLBs included in TLB hierarchy 440 can all be set associative cache memories. Additionally or alternatively, the TLBs included in TLB hierarchy 440 can be a combination of fully associative cache memories and set associative cache memories. In general, fully associative cache memories can have a greater hit ratio, meaning that the likeliness of a cache miss where the data searched for data is not in the TLB is less than in alternative cache memory types such as set-associative cache memories. Further, fully associative cache memories can have certain advantageous features, such as hit-under-miss capability. On the other hand, set-associative cache memories can provide greater memory capacity for a given surface area size on the integrated circuit relative to fully associative cache memories.

In some embodiments, MMU 320 includes one or more arbiters (not shown). These arbiters perform arbitration on memory address translation requests received from SMs 310 included in TPCs 410, from other MMU clients 420 included in TPCs 410, from multiple clients external to TPCs 410, and/or the like. The one or more arbiters select memory address translation requests based on various parameters, including, without limitation, relative priority of the several memory address translation requests, order in which the memory address translation requests are received, and/or the like. including SM memory requests for translation and memory access. The one or more arbiters transmit the selected memory address translation requests in the selected order to TLB hierarchy 440 for memory address translation and memory access.

After completion of first stage address translation from guest virtual address to guest physical address, VMMU 460 performs second stage address translation from guest physical address to system physical address. In so doing, VMMU 460 accesses various data structures from VMMU database 470. VMMU database 470 can be implemented as any high-speed memory, high-performance, low access time memory such as register memory, SRAM, and/or the like. For each guest VM executing in the virtualized computing system, VMMU 460 maintains two data structures stored in VMMU database 470, namely, the VMMU mask and the VMMU valid mask. Further, VMMU maintains a global segment protection mask data structure for the entire GPU/PPU device memory. In some embodiments, the virtualized computing system can support up to 64 VMs at any given time. In such embodiments, VMMU 460 can maintain up to (2×64)+1=129 data structures stored in VMMU database 470.

The capacity C of physical memory accessible by the VMs can be represented as a sequence of S fixed-size VMMU Segments in system physical address space. The value of S can be a design-time parameter based on the expected memory capacity accessible by the VMs. MMU 320 can determine the segment size of each segment in any technically feasible manner. In some embodiments, MMU 320 can divide C, the capacity of the physical memory accessible by the VMs, by S, the number of segments S. MMU 320 can determine the ceiling of C/S by rounding up the result to the nearest integer. MMU 320 can set the segment size as the nearest power of 2 that is greater than the ceiling of C/S.

When generating a new VM, the hypervisor (not shown) provisions, or assigns, the VM with a subset of the total number of VMMU segments. The hypervisor initializes three data structures for the new VM in VMMU database 470. The three data structures for each VM include:(1) a per-VM VMMU segment mask;(2) a per-VM VMMU segment valid mask; and (3) a per-GPU, or per-accelerator processing subsystem 112, segment protection mask. Each of these three data structures includes one bit for each of the S segments accessible in physical memory. Each of the bits in these data structures can have a logic value of TRUE or a logic value of FALSE. As described herein, a logic value of TRUE can be represented by a binary ‘1,’ and a logic value of FALSE can be represented by a binary ‘0.’ Alternatively, a logic value of TRUE can be represented by a binary ‘0,’ and a logic value of FALSE can be represented by a binary ‘1.’

The first data structure is a per-VM VMMU segment mask data structure that includes one bit per system physical address segment. Each bit of the segment mask data structure indicates whether the corresponding system physical address segment is mapped to a guest physical address space. Guest physical address segments are linearly mapped into sequentially increasing system physical address segments that are mapped for this VM by setting subset of bits in VMMU segment mask data structure for that VM. The second data structure is a per-VM VMMU segment valid mask data structure that includes one bit per system physical address segment. Each bit of the segment valid mask data structure indicates whether access to the system physical address segment is valid for the VM even though a guest physical segment is mapped to this system physical segment through the VMMU segment mask. This technique allows generation of a hole or gap (i.e., not memory backed) in the guest physical address space of the VM. Further, this technique allows dynamic allocation and deallocation of memory into this VM memory pool. The third data structure is a per-GP GPU, or per-accelerator processing subsystem 112, segment protection mask data structure for the entire GPU/PPU device memory that includes one bit per system physical address segment. Each bit of the segment protection mask data structure indicates whether the system physical address segment is a protected or secure segment. More specifically, an n-th system physical address segment is protected or secure if the n-th bit of the segment protection mask is set and a VM has access to that protected or secure segment if n-th bit of both the per-VM VMMU segment mask and the per-VM VMMU segment valid mask are set. In other words, a VM accessing a secure and protected system physical segment is allowed access to the segment only if that VM has permission from the per-VM VMMU segment mask and the per-VM VMMU segment valid mask (e.g., the relevant bits in both masks are set to 1, i.e., logic TRUE, for that segment) as well as the condition that the correct security privileges have been configured in the MMU for that VM and the processor.

The hypervisor identifies the segments assigned to a particular VM by the bits in the VMMU segment mask data structure and the bits in the VMMU segment valid mask data structure. The hypervisor can generate a VM in one of two modes:(1) a first mode that supports static, or non-dynamic, memory segment mapping and unmapping; and (2) a second mode that supports dynamic memory segment mapping and unmapping.

When generating a VM in the first mode without dynamic mapping and unmapping support, the hypervisor programs the bits of the VMMU segment mask data structure and the bits in the VMMU segment valid mask data structure to be the same. In so doing, the hypervisor sets bits of both the VMMU segment mask data structure and the VMMU segment valid mask data structure to a logic value of TRUE to indicate that the corresponding segments in system physical memory are allocated to the VM, that the system physical address segment in mapped to a guest physical address segment of the VM, and access to the system physical address segment is valid for the VM.

When generating a VM in the second mode with dynamic mapping and unmapping support, the hypervisor can program the bits of the VMMU segment mask data structure to a logic value of TRUE for some or all VMMU segments, regardless of whether the corresponding system physical address segments are actually allocated to the VM. The hypervisor indicates that a mapped system physical address segment is allocated to the VM by setting the corresponding bit in the VMMU segment valid mask data structure to a logic value of TRUE. The hypervisor only allocates guest physical address segments to a VM if a valid mapping to a corresponding system physical address segment exists, such that processes executing on the VM can access that guest physical address segment. As a result, for a given guest physical address segment, if the corresponding bit of the VMMU segment mask data structure is set to a logic value of TRUE, then the corresponding bit of the VMMU segment valid mask data structure can be set to a logic value of TRUE or a logic value of FALSE. If, on the other hand, if the corresponding bit of the VMMU segment mask data structure is set to a logic value of FALSE, then the corresponding bit of the VMMU segment valid mask data structure is likewise set to a logic value of FALSE.

To add, or map, one or more memory segments to a VM, software executing on the hypervisor can select guest physical address segment(s) with currently invalid mappings and map the guest physical address segment(s) into available system physical address segment(s). An invalid mapping exists when that guest physical segment is currently mapped in the VMMU segment mask (corresponding to the bit set to logical value of TRUE) but not enabled in VMMU segment valid mask (corresponding to the bit set to logical value of FALSE). The software executing on the hypervisor can set the corresponding bit in the VMMU segment valid mask data structure to a logic value of TRUE.

To remove, or unmap, one or more memory segments from a VM, software executing on the hypervisor can select guest physical address segment(s) with currently valid mappings and can set bits in the VMMU segment valid mask data structure corresponding to guest physical address segments being freed to a logic value of FALSE. By setting the bits in the VMMU segment valid mask data structure to a logic value of FALSE, the software executing on the hypervisor frees the corresponding system physical address segments previously mapped to guest physical address segments of the current VM. Once freed, these system physical address segments can be reused or remapped to other VMs executing on the virtualized computing system. Additionally and/or alternatively, these system physical address segments can be subsequently reused or remapped to the current VM.

To perform second stage address translation of a guest physical address segment to a system physical address segment, VMMU 460 determines the guest physical address segment number ‘x’ by performing an integer division. VMMU 460 can divide the guest physical address resulting from first stage address translation by the segment size. VMMU 460 can set the guest physical address segment number as the integer quotient resulting from the integer division. For the x-th guest physical segment mapping of a VM, VMMU 460 searches into the VMMU segment mask of that VM, starting from bit location 0, to find the bit location ‘n’ that has x-th set to a logic value of TRUE where n>=x is always true. If VMMU 460 finds such an ‘n’ bit location within the maximum number of system physical segments, then the x-th guest physical segment is mapped to the n-th system physical segment. In such cases, the corresponding guest physical address is mapped to n*segment_size+offset_in_guest_physical_segment. If the n-th bit in the VMMU segment valid mask is set to a logic value of TRUE, then that VM can access this calculated system physical address.

If VMMU 460 determines that, for a guest physical address being accessed by a memory request, either (1) the VMMU segment mask has no mapping for the guest physical address or (2) the VMMU segment mask has a mapping for the guest physical address but the corresponding bit of the VMMU segment valid mask data structure is set to a logic value of FALSE, then VMMU 460 can generate a page fault. In response to the page fault, MMU 320, the hypervisor executing the hypervisor OS, and/or the like can perform various operations. For example, MMU 320 and/or the hypervisor can determine whether a system physical address segment is available to be mapped to the guest physical address segment. MMU 320 and/or the hypervisor can store the mapping from the guest physical address segment to the system physical address segment in VMMU database 470 can set the corresponding bits of the VMMU segment mask data structure and the VMMU segment valid mask data structure to a logic value of TRUE. MMU 320 and/or the hypervisor can restart the memory request that generated the page fault. Subsequently, MMU 320 can receive the restarted memory request, perform first stage address translation, and employ VMMU 460 to perform second stage address translation.

In some embodiments, one or more VMs executing on the virtualized computing system can be executing in a confidential computing environment. In such cases, VMMU 460 further accesses the per-GPU, or per-accelerator processing subsystem 112, segment protection mask to identify whether a segment is part of the protected memory of a confidential VM. In such cases, a device security manager (DSM) (not shown) can set the bits of the segment protection mask to a logic value of TRUE if the corresponding segments are protected or secure. The DSM can be an operating system or application program executing on a secure microcontroller and/or other secure processor included in the virtualized computing system. In such cases, during second stage address translation, the VM can access segments where the corresponding bits of the segment protection mask to a logic value of FALSE, indicating that the segment is not protected or secure. The VM can also access segments where the corresponding bits of the segment protection mask to a logic value of TRUE, indicating that the segment is protected or secure, but only if the DSM has authorized the particular VM to access the protected or secure segment. If VMMU 460 determines that a memory request is accessing a system physical address segment that is protected or secure, and that the VM is not authorized to access the protected or secure address segment, then VMMU 460 denies the memory request. The DSM and VMMU 460 thereby use the bits of the segment protection mask to enforce appropriate access control checks for each memory request generated in a confidential computing environment.

It will be appreciated that the system shown herein is illustrative and that variations and modifications are possible. MMU 320 translates memory addresses for any and/or all memory clients included in GPCs 208. In that regard, MMU 320 can include any number of additional arbiters and TLBs (not shown) that translate memory addresses included in memory requests generated by other processors and/or components included in GPCs 208 in addition to the processors and components shown in FIG. 4. Although FIG. 4 shows a single MMU 320, memory management subsystem 400 can include any number of MMUs 320. In some embodiments, memory management subsystem 400 can include 1, 2, or 3 MMUs 320 per GPC 208. The techniques performed by memory management subsystem 400 are described in the context of requests generated by SMs 310 included in a GPC 208. Additionally or alternatively, the techniques performed by memory management subsystem 400 can be in the context of requests generated by any type of processor and/or device, including, without limitation, CPUs, GPUs, DMA units, IPUs, NPUs, TPUs, NNPs, DPUs, VPUs, ASICs, FPGAs, and/or the like, in any combination.

The total memory space managed by memory management subsystem 400 can be any amount of memory. Further, memory management subsystem 400 can divide the total memory space into any number of segments. Accordingly, the size of each memory segment can be any amount. TLBs included in TLB hierarchy 440 can include any number of cache lines, and each cache line can store any number of page table entries. TLBs included in TLB hierarchy 440 can be implemented as any high-speed memory, such as register memory, SRAM, and/or the like.

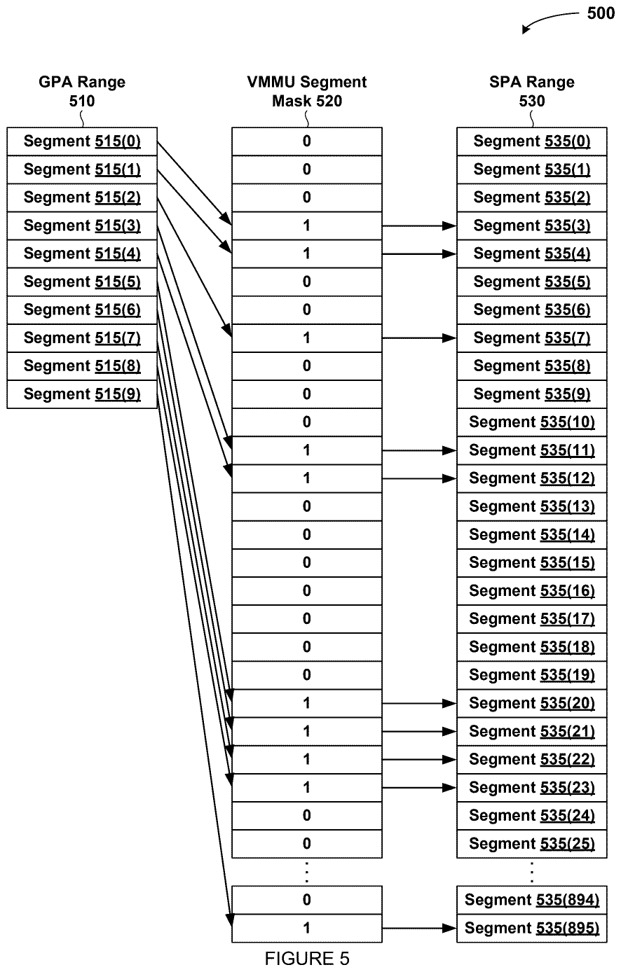

FIG. 5 illustrates how the memory management subsystem 400 of FIG. 4 maps guest physical address segments to system physical address segments, according to various embodiments. As shown, a VM database 500 includes, without limitation, a GPA range 510, a VMMU segment mask 520, and an SPA range 530. In some embodiments, VMMU 460 maintains a separate VM database 500 in VMMU database 470 for each of the VMs currently executing in the virtualized computing system.

GPA range 510 includes ten GPA segments 515(0) . . . 525(9). Each of the ten GPA segments 515 points to corresponding bits in VMMU segment mask 520 and corresponding SPA segments 535 in SPA range 530. VMMU segment mask 520 and SPA range 530 have entries for each of the 896 segments 535(0) . . . 535 (895) included in the physical memory represented by SPA range 530. In particular, GPA segment 515(0) of GPA range 510 maps to SPA segment 535(3) of SPA range 530. GPA segment 515(0) further points to a corresponding bit in VMMU segment mask 520 which is set to a logic value of true, indicating that GPA segment 515(0) is currently mapped to SPA segment 535(3). Likewise, GPA segment 515(1) of GPA range 510 maps to SPA segment 535(4) of SPA range 530. GPA segment 515(1) further points to a corresponding bit in VMMU segment mask 520 which is set to a logic value of true, indicating that GPA segment 515(1) is currently mapped to SPA segment 535(4). Similarly, GPA segments 515(2), 515(3), 515(4), 515(5), 515(6), 515(7), 515(8), and 515(9) of GPA range 510 map to SPA segments 535(7), 535(11), 535(12), 535(20), 535(21), 535(22), 535(23), 535(895) of SPA range 530, respectively. GPA segments 515(2), 515(3), 515(4), 515(5), 515(6), 515(7), 515(8), and 515(9) further point to corresponding bits in VMMU segment mask 520 which are set to a logic value of TRUE, indicating that GPA segments 515(2), 515(3), 515(4), 515(5), 515(6), 515(7), 515(8), and 515(9) are currently mapped to SPA segments 535(7), 535(11), 535(12), 535(20), 535(21), 535(22), 535(23), 535(895), respectively.

The remaining SPA segments of SPA range 530 are not mapped to the current VM represented by VM database 500. Consequently, the bits of VMMU segment mask 520 corresponding to those SPA segments 535 are set to a logic value of FALSE. In general, as the segment numbers of the GPA segments 515 in GPA range 510 monotonically increase, the segment numbers of the corresponding SPA segments 535 in SPA range 530 that are mapped to those GPA segments 515 also monotonically increase.

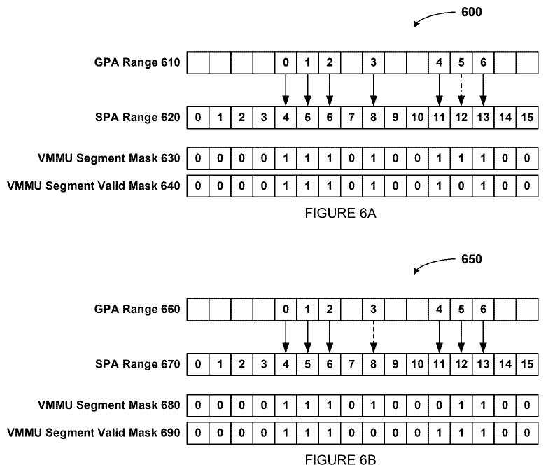

FIGS. 6A-6B illustrate how the memory management subsystem 400 of FIG. 4 manages dynamic mapping of guest physical address segments to system physical address segments using the per-VM VMMU segment mask and the per-VM VMMU segment valid mask, according to various embodiments. As shown in FIG. 6A, a VM database 600 includes, without limitation, a GPA range 610, an SPA range 620, a VMMU segment mask 630, and a VMMU segment valid mask 640. In some embodiments, VMMU 460 maintains a separate VM database 600 in VMMU database 470 for each of the VMs currently executing in the virtualized computing system.

SPA range 620 includes 16 SPA segments that are numbered sequentially from 0 through 15. GPA range 610 indicates that 6 GPA segments, numbered 0, 1, 2, 3, 4, 5, and 6, are mapped to SPA segments 4, 5, 6, 8, 11, 12, and 13 of SPA range 620, respectively. The bits of VMMU segment mask 630 corresponding to SPA segments 4, 5, 6, 8, 11, 12, and 13 of SPA range 620 are set to a logic value of TRUE, indicating that those SPA segments of SPA range 620 are currently mapped to GPA segments of GPA range 610. The bits of VMMU segment valid mask 640 corresponding to SPA segments 4, 5, 6, 8, 11, and 13 of SPA range 620 are set to a logic value of TRUE, indicating that those SPA segments of SPA range 620 can be validly accessed through GPA segments of GPA range 610. GPA segment 5 of GPA range 610 is currently mapped to SPA segment 12 of SPA range 620, as indicated by the dashed arrow between GPA segment 5 and SPA segment 12 and by the corresponding bit of VMMU segment mask 630 being set to a logic value of TRUE. However, the VM cannot validly access data in GPA segment 5, corresponding to SPA segment 12, because the corresponding bit of VMMU segment valid mask 640 is set to a logic value of FALSE. If the VM executes a memory request with a guest virtual address that maps to a guest physical address within GPA segment 5, the MMU 320 issues a page fault.

Subsequently, as shown in VM database 650 of FIG. 6B, the hypervisor has set GPA segment 3 of GPA range 660, corresponding to SPA segment 8 of SPA range 670, as invalid. Accordingly, the hypervisor has maintained the bit in VMMU segment mask 680 corresponding to SPA segment 8 as a logic value of TRUE, and has set the bit in VMMU segment valid mask 690 corresponding to SPA segment 8 to a logic value of FALSE. As a result, the VM cannot validly access data in GPA segment 3, corresponding to SPA segment 8, because the corresponding bit of VMMU segment valid mask 690 is set to a logic value of FALSE. If the VM executes a memory request with a guest virtual address that maps to a guest physical address within GPA segment 3, the MMU 320 issues a page fault.

Further, the hypervisor has set GPA segment 5 of GPA range 660, corresponding to SPA segment 12 of SPA range 670, as valid. Accordingly, the hypervisor has maintained the bit in VMMU segment mask 680 corresponding to SPA segment 8 as a logic value of TRUE, and has set the bit in VMMU segment valid mask 690 corresponding to SPA segment 8 to a logic value of TRUE. As a result, the VM can validly access data in GPA segment 5, corresponding to SPA segment 12, because the corresponding bit of VMMU segment valid mask 690 is set to a logic value of TRUE. If the VM now executes a memory request with a guest virtual address that maps to a guest physical address within GPA segment 5, the MMU 320 does not issue a page fault.

With this technique, removing an SPA segment from, and/or adding an SPA segment to, the middle of the guest physical memory space does not affect the segments that follow the removed or added segment. Instead, the hypervisor can set SPA segments as valid or invalid for access by the VM in guest physical address space by setting corresponding bits in VMMU segment valid mask 690 to a logic value of TRUE or FALSE, respectively. The hypervisor does not need to copy data from one SPA segments to another when removing or adding segments to guest physical address space.

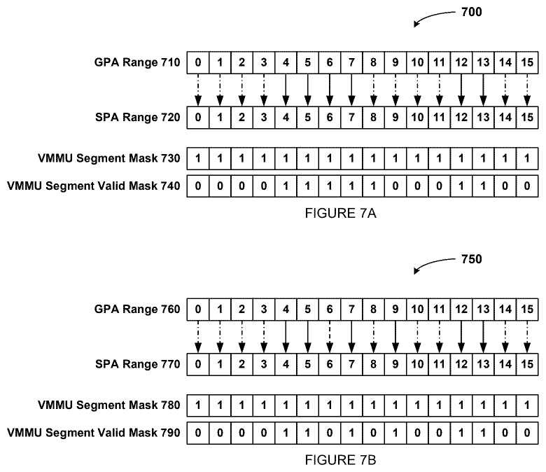

FIGS. 7A-7B illustrate how the memory management subsystem 400 of FIG. 4 manages static mapping of guest physical address segments to system physical address segments using the per-VM VMMU segment mask and the per-VM VMMU segment valid mask, according to various embodiments. As shown in FIG. 7A, a VM database 700 includes, without limitation, a GPA range 710, an SPA range 720, a VMMU segment mask 730, and a VMMU segment valid mask 740. In some embodiments, VMMU 460 maintains a separate VM database 700 in VMMU database 470 for each of the VMs currently executing in the virtualized computing system.

SPA range 720 includes 16 SPA segments that are numbered sequentially from 0 through 15. GPA range 710 indicates that 16 GPA segments, numbered sequentially from 0 through 15, are mapped to SPA segments 0 through 15 of SPA range 720, respectively. The bits of VMMU segment mask 730 corresponding to SPA segments 0 through 15 of SPA range 720 are set to a logic value of TRUE, indicating that those SPA segments of SPA range 720 are currently mapped to GPA segments of GPA range 710. The bits of VMMU segment valid mask 740 corresponding to SPA segments 4, 5, 6, 7, 12, and 13 of SPA range 720 are set to a logic value of TRUE, indicating that those SPA segments of SPA range 720 can be validly accessed through GPA segments of GPA range 710. GPA segments 0-3, 8-11, and 14-15 of GPA range 710 are currently mapped to SPA segments 0-3, 8-11, and 14-15 of SPA range 720, as indicated by the dashed arrows between GPA segments 0-3, 8-11, and 14-15 and SPA segments 0-3, 8-11, and 14-15, respectively, and by the corresponding bits of VMMU segment mask 730 being set to a logic value of TRUE. However, the VM cannot validly access data in GPA segments 0-3, 8-11, and 14-15, corresponding to SPA segments 0-3, 8-11, and 14-15, because the corresponding bit of VMMU segment valid mask 740 is set to a logic value of FALSE. If the VM executes a memory request with a guest virtual address that maps to a guest physical address within any of GPA segments 0-3, 8-11, and 14-15, the MMU 320 issues a page fault.

Subsequently, as shown in VM database 750 of FIG. 7B, the hypervisor has set GPA segment 6 of GPA range 760, corresponding to SPA segment 6 of SPA range 770, as invalid. Accordingly, the hypervisor has maintained the bit in VMMU segment mask 780 corresponding to SPA segment 6 as a logic value of TRUE, and has set the bit in VMMU segment valid mask 790 corresponding to SPA segment 6 to a logic value of FALSE. As a result, the VM cannot validly access data in GPA segment 6, corresponding to SPA segment 6, because the corresponding bit of VMMU segment valid mask 790 is set to a logic value of FALSE. If the VM now executes a memory request with a guest virtual address that maps to a guest physical address within GPA segments 6, the MMU 320 issues a page fault.

Further, the hypervisor has set GPA segment 9 of GPA range 760, corresponding to SPA segment 9 of SPA range 770, as valid. Accordingly, the hypervisor has maintained the bit in VMMU segment mask 780 corresponding to SPA segment 9 as a logic value of TRUE, and has set the bit in VMMU segment valid mask 790 corresponding to SPA segment 9 to a logic value of TRUE. As a result, the VM can validly access data in GPA segment 9, corresponding to SPA segment 9, because the corresponding bit of VMMU segment valid mask 790 is set to a logic value of TRUE. If the VM now executes a memory request with a guest virtual address that maps to a guest physical address within GPA segments 9, the MMU 320 does not issue a page fault.

With this technique, removing an SPA segment from, and/or adding an SPA segment to, the middle of the guest physical memory space does not affect the segments that follow the removed or added segment. Instead, the hypervisor can set SPA segments as valid or invalid for access by the VM in guest physical address space by setting corresponding bits in VMMU segment valid mask 790 to a logic value of TRUE or FALSE, respectively. The hypervisor does not need to copy data from one SPA segments to another when removing or adding segments to guest physical address space.

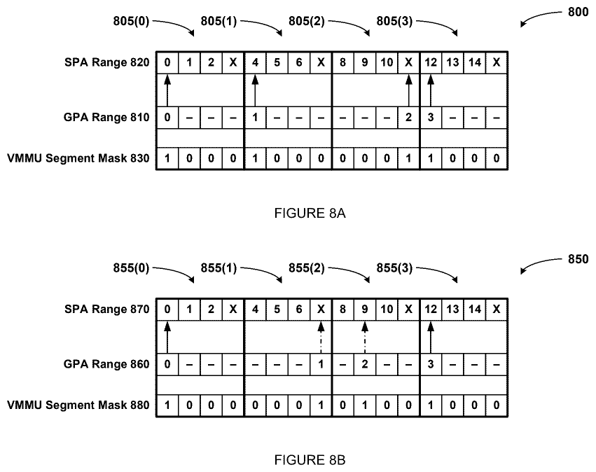

FIGS. 8A-8B illustrate how the memory management subsystem 400 of FIG. 4 manages mapping of guest physical address segments to system physical address segments with a fixed number of segments per VM using the per-VM VMMU segment mask, according to various embodiments. As shown in FIG. 8A, a VM database 800 includes, without limitation, a GPA range 810, an SPA range 820, and a VMMU segment mask 830. In some embodiments, VMMU 460 maintains a separate VM database 800 in VMMU database 470 for each of the VMs currently executing in the virtualized computing system.

The GPA segments of GPA range 810 and the SPA segments of SPA range 820 are organized into multiple units 805(0), 805(1), 805(2), and 805(3). Each of the multiple units 805(0), 805(1), 805(2), and 805(3) includes four GPA segments and four SPA segments. The SPA segments of each unit 805 include multiple active SPA segments and one dummy segment. Specifically, unit 805(0) includes 3 active SPA segments numbered 0, 1, and 2, and a dummy segment labeled X. Likewise, unit 805(1) includes 3 active SPA segments numbered 4, 5, and 6, and a dummy segment labeled X. Unit 805(2) includes 3 active SPA segments numbered 8, 9, and 10, and a dummy segment labeled X. Unit 805(3) includes 3 active SPA segments numbered 12, 13, and 14, and a dummy segment labeled X.

The hypervisor can allocate up to one SPA segment of each unit 805 in SPA range 820 to a GPA segment in GPA range 810. GPA range 810 indicates that 3 GPA segments, numbered 0, 1, and 3, are mapped to SPA segments 0, 4, and 12 of units 805(0), 805(1), and 805(3) in SPA range 820, respectively. GPA range 810 further indicates that the GPA segment numbered 2 is mapped to the dummy SPA segment of unit 805(2) in SPA range 820. The bits of VMMU segment mask 830 corresponding to SPA segment 0 of unit 805(0), SPA segment 4 of unit 805(1), the dummy SPA segment of unit 805(2), and SPA segment 12 of unit 805(3) of SPA range 820 are set to a logic value of TRUE, indicating that those SPA segments of SPA range 820 are currently mapped to GPA segments of GPA range 810.

Subsequently, as shown in VM database 850 of FIG. 8B, the hypervisor has remapped GPA segment 1 of unit 855(1) of GPA range 860 from SPA segment 4 of SPA range 870 to the dummy segment of unit 855(1). Accordingly, the hypervisor has set the bit in VMMU segment mask 880 corresponding to SPA segment 4 of unit 855(1) to a logic value of FALSE. Further, the hypervisor has set the bit in VMMU segment mask 880 corresponding to the dummy SPA segment of unit 855(1) to a logic value of TRUE. In addition, the hypervisor has remapped GPA segment 2 of unit 855(2) of GPA range 860 from the dummy segment of unit 855(2) to SPA segment 9 of SPA range 870. Accordingly, the hypervisor has set the bit in VMMU segment mask 880 corresponding to the dummy segment of unit 855(2) to a logic value of FALSE. Further, the hypervisor has set the bit in VMMU segment mask 880 corresponding to SPA segment 9 of unit 855(1) to a logic value of TRUE. The hypervisor has maintained the existing configuration of units 855(0) and 855(3).

With these techniques, the hypervisor can move assignments of GPA segments to different active segments and/or the dummy segment in each unit 855. However, with these techniques, each unit maintains a dummy segment. As shown in FIG. 8B, this includes one dummy segment for every four segments in a unit, reducing the active segment memory in a unit by 25%. Further, the dummy segments can present a data security risk. For example, when the hypervisor reassigns GPA segment 1 from SPA segment 4 to the dummy segment, the dummy segment could include residual data from a prior assignment of the dummy segment to a different VM executing in the virtualized computing system. Similarly, when the hypervisor reassigns GPA segment 2 from the dummy segment to SPA segment 9, the dummy segment could include residual data from the current VM that can be accessed via a subsequent assignment of the dummy segment to a different VM executing in the virtualized computing system. For this reason, the hypervisor and/or the VM scrub the data stored in the system physical segment when the ownership of the system physical segment changes.

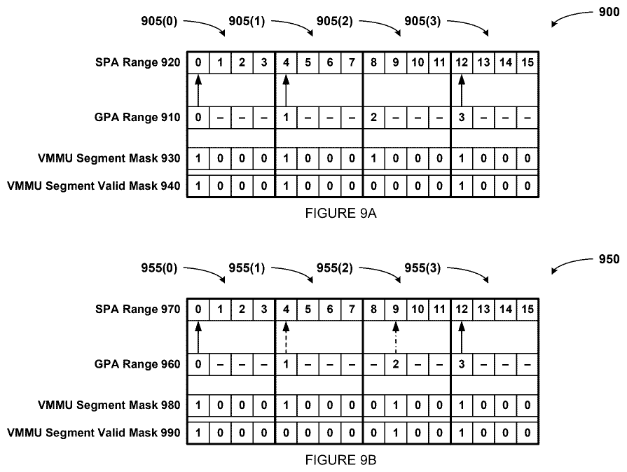

FIGS. 9A-9B illustrate how the memory management subsystem 400 of FIG. 4 manages mapping of guest physical address segments to system physical address segments with a fixed number of segments per VM using the per-VM VMMU segment mask and the per-VM VMMU segment valid mask, according to various embodiments. As shown in FIG. 9A, a VM database 900 includes, without limitation, a GPA range 910, an SPA range 920, a VMMU segment mask 930, and a VMMU segment valid mask 940. In some embodiments, VMMU 460 maintains a separate VM database 900 in VMMU database 470 for each of the VMs currently executing in the virtualized computing system.

The GPA segments of GPA range 910 and the SPA segments of SPA range 920 are organized into multiple units 905(0), 905(1), 905(2), and 905(3). Each of the multiple units 905(0), 905(1), 905(2), and 905(3) includes four GPA segments and four SPA segments. The SPA segments of each unit 905 includes multiple active SPA segments. Specifically, unit 905(0) includes 4 active SPA segments that are numbered sequentially from 0 through 3. Likewise, unit 905(1) includes 4 active SPA segments that are numbered sequentially from 4 through 7. Unit 905(2) includes 4 active SPA segments that are numbered sequentially from 8 through 11. Unit 905(3) includes 4 active SPA segments that are numbered sequentially from 12 through 15.

The hypervisor can allocate up to one SPA segment of each unit 905 in SPA range 920 to a GPA segment in GPA range 910. GPA range 910 indicates that 3 GPA segments, numbered 0, 1, and 3, are mapped to SPA segments 0, 4, and 12 of units 905(0), 905(1), and 905(3) in SPA range 920, respectively. GPA range 910 further indicates that the GPA segment numbered 2 is mapped to SPA segment 8 unit 905(2) in SPA range 920, but is not currently valid for access by the VM. The bits of VMMU segment mask 930 corresponding to SPA segment 0 of unit 905(0), SPA segment 4 of unit 905(1), SPA segment 8 of unit 905(2), and SPA segment 12 of unit 905(3) of SPA range 920 are set to a logic value of TRUE, indicating that those SPA segments of SPA range 920 are currently mapped to GPA segments of GPA range 910. The bits of VMMU segment valid mask 940 corresponding to SPA segment 0 of unit 905(0), SPA segment 4 of unit 905(1), and SPA segment 12 of unit 905(3) of SPA range 920 are set to a logic value of TRUE, indicating that those SPA segments of SPA range 920 are currently valid for access by the VM via the corresponding GPA segments of GPA range 910.

Subsequently, as shown in VM database 950 of FIG. 9B, the hypervisor has disabled GPA segment 1 of unit 955(1) of GPA range 960, while maintaining the mapping of GPA segment 1 to SPA segment 4 of SPA range 970. Accordingly, the hypervisor has set the bit in VMMU segment valid mask 990 corresponding to SPA segment 4 of unit 955(1) to a logic value of FALSE. The hypervisor has maintained the bit in VMMU segment mask 980 corresponding to SPA segment 4 of unit 955(1) at a logic value of TRUE. In addition, the hypervisor has enabled segment 2 of unit 955(2) of GPA range 960 and has remapped GPA segment 2 of unit 955(2) of GPA range 960 from SPA segment 8 of SPA range 970 to SPA segment 9 of SPA range 970. Accordingly, the hypervisor has set the bit in VMMU segment mask 980 corresponding to SPA segment 8 of SPA range 970 to a logic value of FALSE. The hypervisor has set the bit in VMMU segment mask 980 corresponding to SPA segment 9 of SPA range 970 to a logic value of TRUE. Further, the hypervisor has set the bit in VMMU segment valid mask 990 corresponding to SPA segment 9 of unit 955(1) to a logic value of TRUE. The hypervisor has maintained the existing configuration of units 955(0) and 955(3). By appropriately setting the valid bits included in VMMU segment valid mask 990, the hypervisor can map, unmap, and remap SPA segments to GPA segments without the use of dummy segments and without the potential security issues described in conjunction with FIGS. 8A-8B.

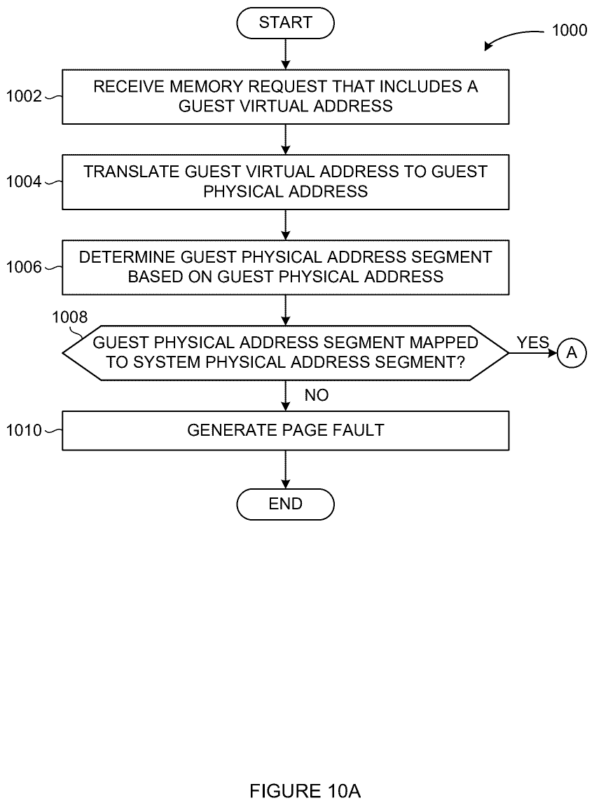

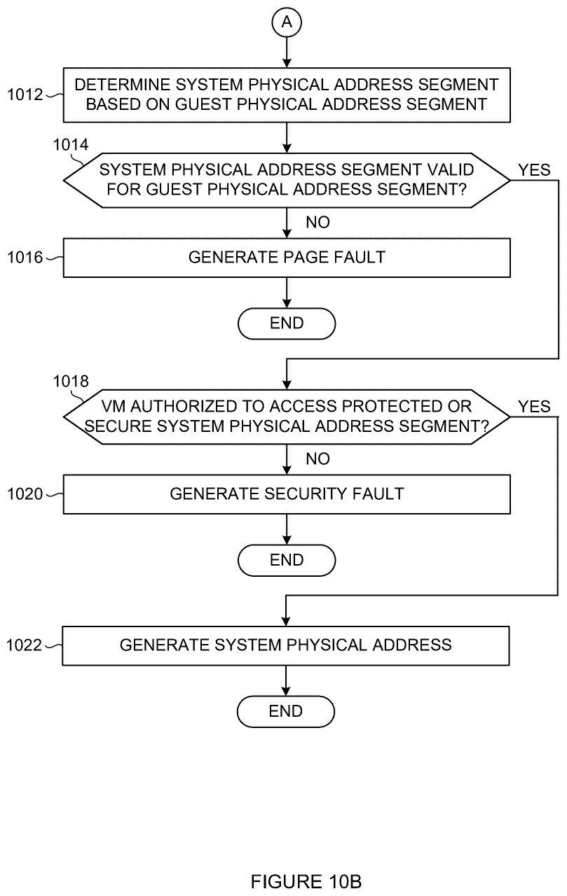

FIGS. 10A-10B set forth a flow diagram of method steps for performing address translation with the memory management subsystem 400 of FIG. 4, according to various embodiments. The method steps can be performed by memory management subsystem 400 of FIG. 4. Additionally or alternatively, the method steps can be performed by one or more alternative accelerators including, without limitation, CPUs, GPUs, DMA units, IPUs, NPUs, TPUs, NNPs, DPUs, VPUs, ASICs, FPGAS, and/or the like, in any combination. Although the method steps are described in conjunction with the systems of FIGS. 1-9B, persons of ordinary skill in the art will understand that any system configured to perform the method steps, in any order, is within the scope of the present disclosure.

As shown, a method 1000 begins at step 1002, where memory management subsystem 400 receives a memory request that includes a guest virtual address. Memory management subsystem 400 includes an MMU 320 with one or more arbiters and a TLB hierarchy 440 that receive memory requests that include memory addresses for translation from SMs 310 and other MMU clients 420. The arbiters determine the relative priority of the memory requests and sort the memory requests in order of priority. In this manner, MMU 320 can perform address translations for SMs 310 and other MMU clients 420 in order of priority. Upon sorting memory requests in order of priority, an arbiter selects a memory request that includes a guest virtual address for first stage address translation.

At step 1004, memory management subsystem 400 translates the guest virtual address to a guest physical address. Memory management subsystem 400 can search one or more uTLBs and/or TLBs for recent address translations to determine whether at least one uTLB and/or TLB includes an entry with a translation for the current guest virtual address to a corresponding guest physical address. If at least one uTLB and/or TLB includes an entry with a translation for the current guest virtual address to a corresponding guest physical address, then memory management subsystem 400 retrieves the corresponding guest physical address from the entry. Otherwise, memory management subsystem 400 performs a multilevel page table search to determine the guest physical address. The page tables can be stored in a main memory, such as PP memory 204, system memory 104, and/or the like.

At step 1006, memory management subsystem 400 determines the guest physical address segment based on the guest physical address. VMMU 460 included in memory management subsystem 400 determines the guest physical address segment number by performing an integer division. VMMU 460 can divide the guest physical address resulting from step 1004 by the segment size. VMMU 460 can set the guest physical address segment number as the integer quotient resulting from the integer division.

At step 1008, memory management subsystem 400 determines whether the guest physical address segment is mapped to a system physical address segment. In so doing, VMMU 460 searches a first data structure. This first data structure is a per-VM VMMU segment mask data structure that includes one bit per system physical address segment. Each bit of the segment mask data structure indicates whether a mapping of the guest physical address segment to a system physical address segment exists.

If the guest physical address segment is not mapped to a system physical address segment, then the method proceeds to step 1010, where memory management subsystem 400 generates a page fault. In response to the page fault, MMU 320, the hypervisor executing the hypervisor OS, and/or the like can perform various operations. For example, MMU 320 and/or the hypervisor can determine whether a system physical address segment is available to be mapped to the guest physical address segment. MMU 320 and/or the hypervisor can store the mapping from the guest physical address segment to the system physical address segment in VMMU database 470 can set the corresponding bits of the VMMU segment mask data structure and the VMMU segment valid mask data structure to a logic value of TRUE. MMU 320 and/or the hypervisor can restart the memory request that generated the page fault. Subsequently, memory management subsystem 400 can process the restarted memory request, via the steps of method 1000. The method 1000 then terminates. Alternatively, the method 1000 returns to step 1002 to receive additional memory requests that include guest virtual addresses for translation.

Returning to step 1008, if the guest physical address segment is mapped to a system physical address segment, then the method proceeds to step 1012, where memory management subsystem 400, memory management subsystem 400 determines the system physical address segment based on the guest physical address segment. VMMU 460 searches a guest physical address segment to system physical address segment mapping array stored in VMMU database 470. If VMMU 460 locates the guest physical address segment number in the guest physical address segment portion of the mapping array, then VMMU 460 retrieves the system physical address segment number corresponding to the guest physical address segment number.

At step 1014, memory management subsystem 400 determines whether the system physical address segment is valid for the guest physical address segment. In so doing, VMMU 460 searches a second data structure. This second data structure is a per-VM VMMU segment valid mask data structure that includes one bit per system physical address segment. Each bit of the segment valid mask data structure indicates whether access to the system physical address segment is valid for the processor that executed a memory request that includes the guest virtual address.

If the system physical address segment is not valid for the guest physical address segment, then the method proceeds to step 1016, where memory management subsystem 400 generates a page fault. In response to the page fault, MMU 320, the hypervisor executing the hypervisor OS, and/or the like can perform various operations. For example, MMU 320 and/or the hypervisor can determine whether a system physical address segment is available to be mapped to the guest physical address segment. MMU 320 and/or the hypervisor can store the mapping from the guest physical address segment to the system physical address segment in VMMU database 470 can set the corresponding bits of the VMMU segment mask data structure and the VMMU segment valid mask data structure to a logic value of TRUE. MMU 320 and/or the hypervisor can restart the memory request that generated the page fault. Subsequently, memory management subsystem 400 can process the restarted memory request, via the steps of method 1000. The method 1000 then terminates. Alternatively, the method 1000 returns to step 1002 to receive additional memory requests that include guest virtual addresses for translation.

Returning to step 1014, if the system physical address segment is valid for the guest physical address segment, then the method proceeds to step 1018, where memory management subsystem 400 determines whether the virtual machine (VM) is authorized to access a protected or secure system physical address segment. In so doing, VMMU 460 searches a third data structure. This third data structure is a global segment protection mask data structure for the entire GPU/PPU device memory that includes one bit per system physical address segment. Each bit of the segment protection mask data structure indicates whether the system physical address segment is a protected or secure segment. A VM accessing a secure and protected system physical segment is allowed access to the segment only if that VM has permission from the per-VM VMMU segment mask and the per-VM VMMU segment valid mask (e.g., the relevant bits in both masks are set to 1, i.e., logic TRUE, for that segment) as well as the condition that the correct security privileges have been configured in the MMU for that VM and the processor.

If the VM is not authorized to access a protected or secure system physical address segment, then the method proceeds to step 1020, where memory management subsystem 400 generates a security fault. The security fault indicates that the system physical address segment mapped to the guest physical address segment is a protected or secured segment and that the VM issuing the memory request is not authorized to access the segment. As a result, the memory request is blocked from execution. The method 1000 then terminates. Alternatively, the method 1000 returns to step 1002 to receive additional memory requests that include guest virtual addresses for translation.

Returning to step 1018, if the VM is authorized to access the protected or secure system physical address segment, or if the segment is not protected or secure, then the method proceeds to step 1022. At step 1022, memory management subsystem 400 generates a system physical address. VMMU 460 sets the base address of the corresponding system physical address segment as the segment size multiplied by the corresponding bit position of the matching guest physical address segment number entry in the VMMU segment valid mask data structure. To this base address, VMMU 460 adds the modulo resulting from the integer division performed at step 1006. The method 1000 then terminates. Alternatively, the method 1000 returns to step 1002 to receive additional memory requests that include guest virtual addresses for translation.

In sum, the disclosed embodiments include techniques for translating memory addresses in a virtualized computing system. In response to receiving a guest virtual memory address associated with a memory request, the virtualized computing system performs two-stage memory address translation:(1) a first translation stage from a guest virtual memory address to a guest physical memory address; and (2) a second translation stage from a guest physical memory address to a system physical memory address. The first translation stage can include multilevel address translation involving traversing through multiple page tables stored in memory. Recent translations resulting from this first translation stage can be stored in a TLB.

The second translation stage includes a virtualization mechanism referred to as a virtual memory management unit (VMMU). The VMMU uses an on-chip high-speed static random access memory (SRAM) and/or other type of on-chip memory in order to avoid page table memory accesses and TLB memory accesses for the second translation stage. The VMMU divides up the entire system physical memory address space into a number of equally sized segments, where each segment is a contiguous block of system physical memory addresses used for memory management and access control. The segments can have configurable sizes, where the segment size is typically set by a secure entity at boot time, such as during power up, after system reset, and/or the like.

For each guest VM executing on the virtualized computing system, the VMMU stores two on-chip data structures in SRAM. The VMMU further stores a global on-chip data structure in SRAM. A first data structure is a per-VM VMMU segment mask data structure that includes one bit per system physical address segment. Each bit of the segment mask data structure indicates whether a mapping of the guest physical address segment to a system physical address segment exists. A second data structure is a per-VM VMMU segment valid mask data structure that includes one bit per system physical address segment. Each bit of the segment valid mask data structure indicates whether access to the system physical address segment is valid for the processor that executed a memory request that includes the guest virtual address. A third data structure is a per-device segment protection mask data structure for the entire GPU/PPU device memory that includes one bit per system physical address segment. Each bit of the segment protection mask data structure indicates whether the system physical address segment is a protected or secure segment. A VM has access to a secure and protected system physical segment only if that VM has permission from the per-VM VMMU segment mask and the per-VM VMMU segment valid mask (e.g., the relevant bits in both masks are set to 1, i.e., logic TRUE, for that segment) as well as the condition that the system physical segment is protected by the segment protected bit mask.

At least one technical advantage of the disclosed techniques relative to the prior art is that, with the disclosed techniques, performing second stage memory address translation in a virtualized computing system can utilize three data structures stored in high-speed local SRAM. By utilizing these three data structures, second stage memory address translation from a GPA to an SPA can be performed within a small number of clock cycles (e.g., ˜4 clock cycles). By contrast conventional techniques perform second stage memory address translation via multiple sequential page table memory accesses, which can consume thousands of clock cycles or more. As a result, performance of second stage memory address translation from GPA to SPA can be significantly improved relative to conventional techniques.

Further, with the virtualization mechanism can perform GVA to SPA translation via multiple sequential page table memory accesses for the first stage memory address translation plus a small number of clock cycles for the second stage memory address translation. By contrast conventional techniques perform GVA to SPA translation via multiple sequential page table memory accesses for first stage memory address translation (GVA to GPA) times multiple sequential page table memory accesses for second stage memory address translation (GPA to SPA). As a result, performance of GVA to SPA translation can also be significantly improved relative to conventional techniques.

Another advantage of the disclosed techniques relative to the prior art is that, with the disclosed techniques, the three data structures can be used to map SPA segments and unmap SPA segments from a VM faster relative to conventional techniques. In addition, a per-device segment protection mask data structure can be used in confidential computing applications to distinguish between protected or secure memory and unprotected or non-secure memory so that security policies can be enforced for confidentiality and integrity of protected data. These advantages represent one or more technological improvements over prior art approaches.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for translating memory addresses in a computing system, the method comprising:
translating a first guest virtual address included in a first memory request to a first guest physical address;
determining a first guest physical address segment based on a first guest physical address;
determining that a mapping of the first guest physical address segment to a first system physical address segment exists;
determining that access to the first system physical address segment is valid for a processor that executed the first memory request; and
determining a first system physical address based on the first guest physical address and on the mapping of the first guest physical address segment to the first system physical address segment.

2. The method of claim 1, wherein determining the first guest physical address segment based on the first guest physical address comprises:
performing a first integer division by dividing the guest physical address by a segment size; and
setting the first guest physical address segment as a first integer quotient resulting from the integer division.

3. The method of claim 2, further comprising:
performing a second integer division by dividing a total size of a system physical memory by a number of segments; and
setting the segment size as a second integer quotient resulting from the second integer division.

4. The method of claim 2, wherein determining the first system physical address comprises:
multiplying the first integer quotient by the segment size to generate a product; and
adding a modulo resulting from the first integer division to the product.

5. The method of claim 1, wherein determining that the mapping of the first guest physical address segment to the first system physical address segment exists comprises:
accessing a data structure that includes, for each system physical address segment, an entry that identifies whether a corresponding system physical address segment is currently mapped to a corresponding guest physical address segment; and
determining that a first entry in the data structure corresponding to the first system physical address segment identifies that the first system physical address segment is currently mapped to the first guest physical address segment.

6. The method of claim 1, wherein determining that access to the first system physical address segment is valid for a processor that executed the first memory request comprises:
accessing a data structure that includes, for each system physical address segment, an entry that identifies whether a corresponding system physical address segment is valid for a corresponding guest physical address segment; and
determining that a first entry in the data structure corresponding to the first system physical address segment identifies that the first system physical address segment is valid for the first guest physical address segment.

7. The method of claim 1, further comprising:
translating a second guest virtual address included in a second memory request to a second guest physical address;
determining a second guest physical address segment based on a second guest physical address;
determining that a mapping of the second guest physical address segment to a second system physical address segment does not exist; and
in response to determining that the mapping of the second guest physical address segment to the second system physical address segment does not exist, generating a page fault.

8. The method of claim 1, further comprising:
translating a second guest virtual address included in a second memory request to a second guest physical address;
determining a second guest physical address segment based on a second guest physical address;
determining that a mapping of the second guest physical address segment to a second system physical address segment exists;
determining that access to the second system physical address segment is not valid for a processor that executed the second memory request; and
in response to determining that access to the second system physical address segment is not valid for the processor that executed the second memory request, generating a page fault.

9. The method of claim 1, further comprising:
determining that the first system physical address segment is a first protected segment; and
determining that a processor that executed the first memory request is authorized to access the first protected segment.

10. The method of claim 9, wherein determining that the processor that executed the first memory request is authorized to access the first protected segment comprises:
accessing a data structure that includes, for each system physical address segment, an entry that identifies whether a corresponding system physical address segment is a protected segment; and
determining that a first entry in the data structure corresponding to the first system physical address segment identifies that the first system physical address segment is the first protected segment.

11. A system, comprising:
a processor that;
executes a first memory request that includes a first guest virtual address; and
a memory management subsystem that is coupled to the processor, and that:
translates a first guest virtual address included in a first memory request to a first guest physical address;
determines a first guest physical address segment based on a first guest physical address;
determines that a mapping of the first guest physical address segment to a first system physical address segment exists;
determines that access to the first system physical address segment is valid for the processor that executed the first memory request; and
determines a first system physical address based on the first guest physical address and on the mapping of the first guest physical address segment to the first system physical address segment.

12. The system of claim 11, wherein, to determine the first guest physical address segment based on the first guest physical address, the memory management subsystem:
performs a first integer division by dividing the guest physical address by a segment size; and
sets the first guest physical address segment as a first integer quotient resulting from the integer division.

13. The system of claim 12, where the memory management subsystem further:
performs a second integer division by dividing a total size of a system physical memory by a number of segments; and
sets the segment size as a second integer quotient resulting from the second integer division.

14. The system of claim 12, wherein, to determine the first system physical address, the memory management subsystem:
multiplies the first integer quotient by the segment size to generate a product; and
adds a modulo resulting from the first integer division to the product.

15. The system of claim 11, wherein, to determine that the mapping of the first guest physical address segment to the first system physical address segment exists, the memory management subsystem:
accesses a data structure that includes, for each system physical address segment, an entry that identifies whether a corresponding system physical address segment is currently mapped to a corresponding guest physical address segment; and
determines that a first entry in the data structure corresponding to the first system physical address segment identifies that the first system physical address segment is currently mapped to the first guest physical address segment.

16. The system of claim 11, wherein, to determine that access to the first system physical address segment is valid for the processor that executed the first memory request, the memory management subsystem:
accesses a data structure that includes, for each system physical address segment, an entry that identifies whether a corresponding system physical address segment is valid for a corresponding guest physical address segment; and
determines that a first entry in the data structure corresponding to the first system physical address segment identifies that the first system physical address segment is valid for the first guest physical address segment.

17. The system of claim 11, wherein the memory management subsystem further:
translates a second guest virtual address included in a second memory request to a second guest physical address;
determines a second guest physical address segment based on a second guest physical address;
determines that a mapping of the second guest physical address segment to a second system physical address segment does not exist; and
in response to determining that the mapping of the second guest physical address segment to the second system physical address segment does not exist, generates a page fault.

18. The system of claim 11, wherein the memory management subsystem further:
translates a second guest virtual address included in a second memory request to a second guest physical address;
determines a second guest physical address segment based on a second guest physical address;
determines that a mapping of the second guest physical address segment to a second system physical address segment exists;
determines that access to the second system physical address segment is not valid for the processor that executed the second memory request; and
in response to determining that access to the second system physical address segment is not valid for the processor that executed the second memory request, generates a page fault.

19. The system of claim 11, wherein the memory management subsystem further:
determines that the first system physical address segment is a first protected segment; and
determines that the processor that executed the first memory request is authorized to access the first protected segment.

20. The system of claim 19, wherein, to determine that the processor that executed the first memory request is authorized to access the first protected segment, the memory management subsystem:
accesses a data structure that includes, for each system physical address segment, an entry that identifies whether a corresponding system physical address segment is a protected segment; and
determines that a first entry in the data structure corresponding to the first system physical address segment identifies that the first system physical address segment is the first protected segment.
